(19) United States
(12) Patent Application Publication
(10) Pub. No.: US 2009/0022357 A1
(43) Pub. Date: Jan. 22, 2009

(54) SYSTEM AND METHOD FOR MAKING PRESENTATIONS OF IMAGES MORE ENJOYABLE

(76) Inventor: Darius KATZ, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/780,661

(22) Filed: Jul. 20, 2007

(51) Int. Cl. G06K 9/00

(52) U.S. Cl. 382/100

(57) ABSTRACT

A method and a system for storing metadata with a digital image, wherein the metadata is associated with the condition at the moment of capturing the image. The metadata is then used by an image viewer for choosing the best image effect when the image is displayed.

### TECHNICAL FIELD

The present invention relates generally to a system and method for making presentations of images more enjoyable by using additional information stored with digital images.

### BACKGROUND ART

Today, there exists an abundance of presentation systems i.e. image viewer, capable of presenting images stored as binary data files on various media, such as CD, hard disks etc. The image data may be stored in various formats, such as jpeg, tiff or bmp. An image viewer is a computer program that displays stored digital image of various kinds of digital image formats. Such software usually renders the image according to properties of the image. Available features of image viewer might be basic viewing operations, such as zooming and rotation, slideshows, printing among others.

The image data files may contain meta-data, i.e. data besides the image data. The meta-data describes the content of the file, including colour depth and display resolution.

The images may be presented as a slideshow, which is a display of series of chosen images. A well organized slide show allows a presenter to lend visual images to an oral presentation. The old adage “A picture is worth a thousands words” hold true, in that a single picture may save a presenter from speaking about descriptive details. For instructional purpose, presentation software is commonly used, and is usually used with the intention of creating a dynamic, audiovisual presentation. Slide shows have artistically uses as well, such as being used as a screensaver, or to provide dynamic imagery of a presentation.

One of several popular special effect used in slideshows is to pan across a photo or zoom in and out as it is displayed. This is known as the “Ken Burns effect”. In the future, watching a slideshow on a screen or display, special image effects will be the rule rather than novelty. Unfortunately are special image effects of today randomized or preset and the watching of the slideshows will not always be that enjoyable.

Thus, it is desirable to provide a system and a method that makes presentations of images more enjoyable.

### SUMMARY OF THE INVENTION

With the above and following description in mind, then an aspect of some embodiments of the present invention is to provide an improved system and a method enhancing emotions during image viewing by use of special image effects, which seeks to mitigate, alleviate or eliminate one or more of the above-identified deficiencies in the art and disadvantages singly or in any combination.

In a first aspect of the invention a method is provided for associating condition information with a digital image, captured by an image forming device. The method may comprise the steps of identifying a condition at the moment the image is captured, creating image metadata by use of the identified condition, storing the image metadata with the digital image, choosing a display effect by using the image metadata and displaying the image by use of the display effect.

Further the step of identifying a condition may comprise capturing a first image before the actual image and a second image after the actual image.

In another aspect of the invention a system is provided for associating condition information with a digital image. The system comprises an image forming device, for capturing and storing a digital image with associated image metadata and a displaying device for presenting the digital image by use of means for displaying the image. The image forming device may comprise means for identifying a condition at the moment the image is captured, means for creating additional image metadata by use of the identified condition and means for storing the additional image metadata with the digital image. Further the displaying device may comprise means for choosing a display effect by using the additional image metadata.

Further the means for identifying a condition may comprise means for identifying conditions at the moment of capturing a first image before the actual image and a second image after the actual image.

In yet another aspect of the invention a computer-readable medium is provided containing program instructions for associating displaying information with a digital image. The instructions may be for identifying a condition at the moment the image is captured, creating image metadata by use of the identified condition, storing the image metadata with the digital image, choosing a display effect by using the image metadata and displaying the image by use of the display effect.

Further the instructions for identifying a condition may include capturing a first image before the actual image and a second image after the actual image.

The display effect may be a Ken Burns effect.

The terminology used herein after is for the purpose of describing particular embodiments only and is not intended to be limiting of the invention. As used herein, the singular forms of “a”, “an” and “the” are intended to include plural forms as well, unless the context clearly indicates otherwise. It should be emphasised that the terms “comprise/comprising” when used in this specification are taken to specify the presence or addition of one or more other features, elements, integers, steps, components or groups thereof.

### BRIEF DESCRIPTION OF THE DRAWINGS

Further objects, features and advantages of the present invention will become apparent from the following detailed description of the invention, wherein embodiments of the invention will be described in more detail with reference to the accompanying drawings, in which:

FIG. 1 is a block diagram illustrating a system for associating condition information with a digital image in accordance with a preferred embodiment of the present invention;

FIG. 2 is a flow diagram illustrating a process for associating condition information with a digital image in accordance with a preferred embodiment of the present invention.

### DETAILED DESCRIPTION

The invention will be described with references to a portable image forming device, which may be any electronic device with an integrated camera, such as a camera phone, PDA, PC among others. The invention is equally applicable in general multimedia players and stationary devices, such as video systems, television systems and stationary computers.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and fully convey to the scope of the invention to those skilled in the art. Like reference signs refer to like elements throughout.

The present invention provides a method for storing metadata with a digital image, where the metadata is associated with the condition at the moment of capturing the image. The metadata is then used by an image viewer for choosing the best image effect when the image is displayed.

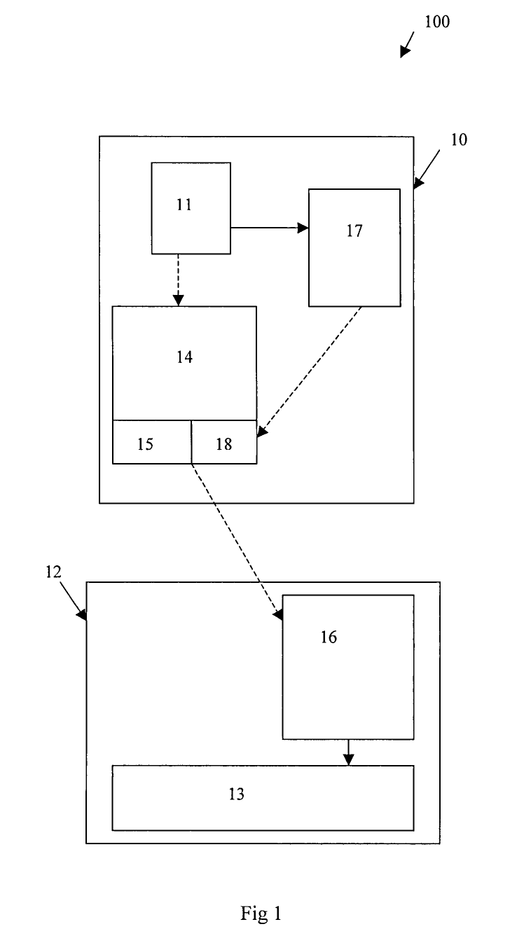

FIG. 1 is a block diagram illustrating a system for storing metadata with an image and displaying the image based on the stored metadata in accordance with a preferred embodiment of the present invention. The system 100 includes an image forming unit 10, comprising a camera unit 11, and a presentation unit 12 comprising a visual display unit 13.

A digital image 14 captured by the camera unit included in the image forming device 10 is shown having associated image metadata 15 that describes and/or categorize the image 14. The image 14 may be stored as any file type including jpeg, tiff or bmp, but may also include audio, on a storage device (not shown), such as a hard drive. The image forming unit 10 further comprises a condition analyser application 17 which identifies the condition at the moment of taking the picture. This condition information is stored as additional metadata 18 with the image 14. The image 14 may be a single still photograph but it is could also be an image from a paused video clip.

Additionally the system 100 may comprise sensors, not shown, for estimating distance to objects in the image 14, which will be stored as additional metadata 18 with the image 14. A face recognition unit, not shown, may also be comprised for recognising where the faces are in the image 14, which also will be stored as additional metadata 18 with the image 14.

The presentation unit 12 comprises an image displaying application 16 capable of opening and displaying images, such as an image viewer, a web browser or other graphical user interface. The displaying application 16 opens and displays the image 14, received from the image forming unit 10, on a visual display 13. The image displaying application 16 uses special image effects, such as Ken Burns effects or other software image effects, when displaying the images 14 and utilizes the additional metadata 18 for choosing which special image effects are most appropriate.

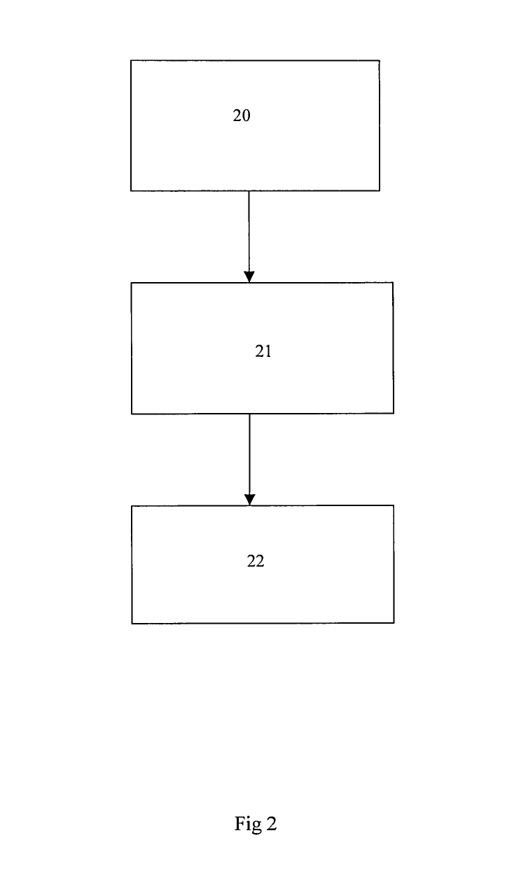

FIG. 2 is a flow diagram illustrating a process for storing additional metadata 18 to a digital image 14 in accordance with a preferred embodiment of the present invention. Referring both to FIG. 1 and FIG. 2, the process begins with step 20 by identifying the condition at the moment of taking the photo, e.g. a skier skies downhill upper left to lower right.

After taking the photo and the condition are identified, in step 21, the information of the condition is stored as metadata 18 with the image 14.

In the next step 22 the image displaying application 16 uses the metadata 18 for choosing appropriate effects when presenting the image on the display unit 13.

In a preferred embodiment the collected metadata 15, 18 is stored with the image 14 in order for the image displaying application 16 to decide the best special image effect in the future, based on the stored additional metadata 18.

In another embodiment an immediate decision of the best special image effect is taken and then stored as additional metadata 18 with the image 14. The image 14 may be shown directly on a display unit 13 or be stored in a storage unit.

In yet another embodiment the additional metadata 18 might be very rough thumbnail-like data that shows the main difference before the image was taken and after the image was taken compared to the actual image 14. These thumbnail-like data is stored as additional metadata 18 with the actual image 14 to be used by the image displaying unit 16 to decide the best special image effect to use. As an example, a skier skis from upper left to lower right. A single image will not indicate in what direction the skier skies. Using the thumbnail-like data as metadata 18 according to the present invention the image 14 “remembers” that the skier progress, since this is shown by the thumbnail-like image sequence stored as additional metadata 18, and when the image 14 is displayed the Ken Burns effect can start in the lower right and pan up to the upper left to get a feeling of speed. In another example, a child runs toward the camera, the image forming unit 10. The metadata 18 shows that the main target is increasing in size and the Ken Burns effect would be a slow zoom to get the feeling of speed, instead of panning which would not be appropriate to get the best emotion when viewing the image.

Other example of metadata that will help the image displaying application 16 to choose the optimal special image effect may be distance to object, movement of camera, picture mode (e.g. portrait, landscape), face recognition, speed estimation, macro mode or other, among others.

The invention may be implemented by means of suitable combinations of hardware and software. The invention is not limited to any particular format of multimedia data and meta-data, though the examples cited above are suitable. Further formats may be developed in the future providing the same technical functions. The scope of the invention is only limited by the claims below.

1. A method for associating condition information with a digital image, comprising the steps of capturing and storing a digital image with associated image metadata, said method further comprising the steps of:
identifying a condition at the moment said image is captured;
storing said identified condition as additional image metadata with said digital image;
choosing a display effect by using said image metadata; and
displaying said image by use of said display effect.

2. The method of claim 1, wherein identifying a condition comprises the steps of identifying conditions at the moment of capturing a first image before said actual image and a second image after said actual image.

3. The method of claim 1, wherein said display effect is a Ken Burns effect.

4. An image system for associating condition information with a digital image, comprising an image forming device for capturing and storing a digital image with associated image metadata and a displaying device for presenting said digital image, wherein said image forming device comprising:
means for identifying a condition at the moment said image is captured; and
means for storing said identified condition as additional image metadata with said digital image,
and wherein said displaying device comprising:
means for choosing a display effect by using said additional image metadata.

5. The image system according to claim 4, wherein means for identifying a condition further comprises means for identifying conditions at the moment of capturing a first image before said actual image and a second image after said actual image.

6. The image system according to claim 4, wherein said display effect is a Ken Burns effect.

7. A computer-readable medium containing program instructions for associating condition information with a digital image, further comprising instructions for
identifying a condition at the moment said image is captured;
storing said identified condition as additional image metadata with said digital image;
choosing a display effect by using said additional image metadata; and
displaying said image by use of said display effect.

8. The computer-readable medium according to claim 7, wherein the instructions for identifying a condition comprises the instructions for identifying conditions at the moment of capturing a first image before said actual image and a second image after said actual image.

9. The computer-readable medium according to claim 7, wherein said display effect is a Ken Burns effect.
